(19) United States
(12) Patent Application Publication
(10) Pub. No.: US 2008/0013780 A1
(43) Pub. Date: Jan. 17, 2008

(54) Speaker device

(76) Inventors: Hiroyuki Kobayashi, Yamagata (JP); Kenichi Kasahara, Yamagata (JP); Shinichi Hayasaka, Yamagata (JP); Toshihiro Hikichi, Yamagata (JP)

Correspondence Address: YOUNG & THOMPSON, 745 SOUTH 23RD STREET, 2ND FLOOR, ARLINGTON, VA, 22202, US

(21) Appl. No.: 11/085,182

(22) Filed: Mar. 22, 2005

(30) Foreign Application Priority Data
Mar. 25, 2004 (JP) 2004-89315

(51) Int. Cl. H04R 1/02

(52) U.S. Cl. 381/398

(57) ABSTRACT

In a speaker device, a supporting member is arranged on a central axis, a diaphragm is provided on an outer circumference of the supporting member, and a damper is provided on the diaphragm. Preferably, the damper has a waterproof property. An inner peripheral edge portion of the damper is fixed to the supporting member on a sound output side with respect to the diaphragm, and an outer peripheral edge portion thereof is fixed to the diaphragm. The damper has a bent raised portion, on the outer peripheral side with respect to the fixing position to the diaphragm. By forming the bent portion on the outer peripheral end of the damper, it can be suppressed or prevented that the outer peripheral edge portion of the damper is deformed by a solvent of an adhesive agent at the time of attaching the outer peripheral edge portion of the damper and the diaphragm.

### TECHNICAL FIELD

The present invention relates to a structure of a speaker device including a waterproof damper.

### BACKGROUND ART

A marine speaker is loaded on a bow or a stern of a ship, for example. Therefore, when water and moisture enter a magnetic circuit, the magnetic circuit sometimes gets rusty. In addition, water sometimes enters the inside of the ship via the marine speaker.

For the purpose of solving such problems, in the marine speaker, by providing a damper having a waterproof property (hereinafter referred to as “waterproof damper”), made of an elastomer material, in addition to an ordinary damper, it is prevented that waterdrops enter a magnetic circuit system and the like. For example, in a case of the marine speaker having a corn-shape diaphragm, an inner peripheral edge portion of the waterproof damper is fixed to a supporting member disposed on a central axis of the marine speaker, and an outer peripheral edge portion thereof is fixed to a sound output surface of the diaphragm via an adhesive agent. Thereby, it is prevented that the waterdrops and the like enter the magnetic circuit system.

Conventionally, there is known a speaker having such a structure that not only the ordinary damper but also an anti-dust damper is provided and an outer peripheral edge portion of the anti-dust damper and the corn-shape diaphragm are attached by the adhesive agent (for example, see Japanese Patent Application Laid-Open (JP-A) No. 8-149589 and No. 8-163692).

Though the outer peripheral edge portion of the waterproof damper is fixed to the diaphragm, since the diaphragm is vibrated at the time of reproducing a sound from the speaker device, sufficient adhesion strength is necessary between the outer peripheral edge portion of the waterproof damper and the diaphragm. However, when the waterproof damper is attached to the diaphragm by the adhesive agent, the outer peripheral edge portion of the waterproof damper is eroded by a solvent of the adhesive agent, and the strength sometimes decreases. In addition, since the waterdrops and the like often enter the marine speaker, the adhesion portion is swelled by moisture, and the strength sometimes decreases. Thus, at the time of reproducing the sound, the outer peripheral edge portion of the waterproof damper problematically peels off the diaphragm.

### DISCLOSURE OF THE INVENTION

As a problem that the invention is to solve, the above problem is taken as an example. An object of the invention is to provide a speaker device capable of stably mounting a waterproof damper to a diaphragm with sufficient strength.

According to one aspect of the present invention, there is provided a speaker device including: a supporting member which is disposed on a central axis of the speaker device; a diaphragm which is provided at an outer circumference of the supporting member; and a damper which has an inner peripheral edge portion fixed to the supporting member on a sound output side with respect to the diaphragm and an outer peripheral edge portion fixed to the diaphragm, wherein the damper has a bent portion, which is raised on a side of the sound output, at an outer peripheral side with respect to a fixing position to the diaphragm.

In the above speaker device, the supporting member is disposed on the central axis, and the diaphragm is provided on the outer circumference of the supporting member. The damper is provided on the diaphragm. In a preferred form, the damper may have a waterproof property. The inner peripheral edge portion of the damper is fixed to the supporting member on the sound output side with respect to the diaphragm, and the outer peripheral edge portion is fixed to the diaphragm. The damper has the bent portion, which is raised from the upside of the diaphragm to the sound output side, on the outer peripheral side with respect to the fixing position to the diaphragm. If the bent portion is formed at the outer peripheral end of the damper, the strength of the damper itself at the outer peripheral edge portion increases. Therefore, the strength of the fixing portion of the damper and the diaphragm can be sufficiently maintained, and the unnecessary vibration of the vibration system can be suppressed.

In a form of the above speaker device, the damper may be attached to the diaphragm at a fixing position on an inner peripheral side with respect to the bent portion. In this case, in a manufacturing process of attaching the damper at the bent portion by the adhesive agent, it can be prevented that the outer peripheral portion of the damper is deformed by dissolution and softening of the damper due to the adhesive agent.

In a preferred example, the speaker device may further include: a frame which holds the supporting member; and another damper which has an inner peripheral edge portion fixed to a member of a vibration system and an outer peripheral edge portion fixed to the frame. In this form, the speaker device may have not only the waterproof damper but also the ordinary damper fixed to the frame and the member of the vibration system such as the voice coil bobbin.

### BRIEF DESCRIPTION OF THE DRAWINGS

FIG. 1A shows a sectional view of a construction of a speaker device according to an embodiment of the present invention, and

FIG. 1B shows a rear view thereof;

FIG. 2 shows an enlarged sectional view of a waterproof damper according to this embodiment; and

FIGS. 3A and 3B are enlarged sectional views for explaining structures and operations of outer peripheral edge portions of an ordinary waterproof damper and the waterproof damper according to this embodiment.

### BEST MODE FOR CARRYING OUT THE INVENTION

Hereinafter, preferred embodiment of the invention will be described by referring to the drawings. The embodiment suppresses or prevents deformation (swell) due to a solvent of the adhesive agent at the time of attaching the outer peripheral edge portion and the diaphragm by forming the bent portion at the outer peripheral edge portion of the waterproof damper.

### [Configuration of Speaker Device]

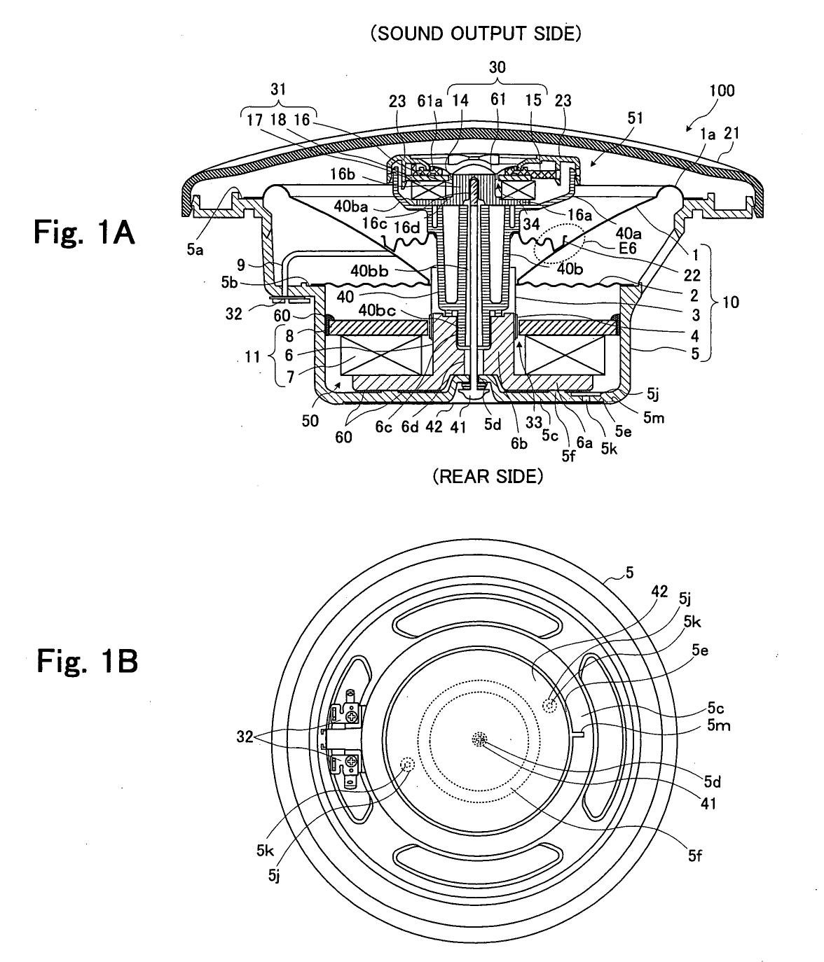

First, in FIGS. 1A and 1B, an outline configuration of a speaker device 100 according to the embodiment of the present invention is schematically shown. FIG. 1A is a sectional view when the speaker device 100 is cut along a plane containing a central axis thereof. FIG. 1B is a rear view of the speaker device 100. The speaker device 100 in the embodiment can be used preferably as a marine speaker. As below, referring to FIGS. 1A and 1B, the configuration etc. of the speaker device 100 of the embodiment will be described.

The speaker device 100 includes a speaker unit 50 for low-frequency band reproduction, a speaker unit 51 for high-frequency band reproduction, and other various kinds of members. The speaker device 100 is a so-called coaxial type two-way speaker, and is configured by coaxially disposing the speaker unit 51 for high-frequency band reproduction at the sound output side and the speaker unit 50 for low-frequency band reproduction at the rear side. Accordingly, the speaker device 100 can realize flat sound reproduction from the low-frequency band to the high-frequency band. Incidentally, the speaker unit 50 for low-frequency band reproduction may be a speaker unit capable of low and middle frequency band reproduction. Further, the speaker unit 51 for high-frequency band reproduction may be a speaker unit capable of high and middle frequency band reproduction.

First, a configuration of the speaker unit 50 for low-frequency band reproduction will be described. The speaker unit 50 for low-frequency band reproduction mainly includes a vibration system 10 having a diaphragm 1, a damper 2, a waterproof damper 22, a voice coil bobbin 3, a voice coil 4 and a resin frame 5, a magnetic circuit system 11 having a pole piece 6, an annular magnet 7 and an annular plate 8, and a resin grille 21.

First, the respective constitutive elements of the vibration system 10 will be described.

The diaphragm 1 is a so-called conical diaphragm, and a separate edge portion 1a is bonded thereto or the diaphragm 1 is formed integrally with the edge portion 1a. Various kinds of materials such as paper, polymer or metal can be applied to the diaphragm 1 according to various kinds of application. The outer peripheral edge of the diaphragm 1, namely, the lower end part of the edge portion 1a is fixed onto a first flange portion 5a located at the upper part of the resin frame 5. On the other hand, the inner peripheral edge of the diaphragm 1 is fixed onto the vicinity of the upper end of the outer circumferential wall of the voice coil bobbin 3.

The damper 2 is made of a material of cloth impregnated with a thermosetting resin such as phenol resin or the like, and plural corrugations are concentrically formed. The damper 2 movably supports the voice coil bobbin 3. The inner peripheral edge of the damper 2 is fixed to the outer circumferential wall of the voice coil bobbin 3. On the other hand, the outer peripheral edge of the damper 2 is fixed onto a second flange portion 5b formed in the vicinity of the central part of the resin frame 5.

The waterproof damper 22 fulfills a function of preventing water droplets etc. from entering from the sound output side into the magnetic circuit system 11 etc. For the purpose, as a material for the waterproof damper 22, for example, a material such as thermoplastic elastomer is appropriate. The outer peripheral edge of the waterproof damper 22 is mounted in a predetermined position of the diaphragm 1, and the inner peripheral edge of the waterproof damper 22 is mounted to the outer circumferential wall of a connecting portion 40b of a supporting member 40, which will be described later.

The voice coil bobbin 3 has a substantially cylindrical shape. The voice coil 4 is wound around the outer circumferential wall of the lower end part of the voice coil bobbin 3. Further, the outer circumferential wall of the lower end part of the voice coil bobbin 3 faces the inner circumferential wall of the annular plate 8 with a certain space therebetween. Furthermore, the inner circumferential wall of the lower end part of the voice coil bobbin 3 faces the outer circumferential wall of the upper end part of the pole piece 6 with a certain space therebetween. Thus, a gap (magnetic gap 33) is formed between the outer circumferential wall of the upper end part of the pole piece 6 and the inner circumferential wall of the plate 8.

The voice coil 4 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires 9 in the predetermined position of the diaphragm 1 and the other ends of the respective tinsel wires 9 are electrically connected to a connection terminal 32. To the voice coil 4, electric signals for one channel are input from an amplifier (not shown) side via the connection terminal 32 and the tinsel wires 9.

The resin frame 5 is a frame made of a resin material. Onto the resin frame 5, various components of the speaker device 100 are fixed, and the resin frame 5 serves to support the speaker device 100. The resin frame 5 has a shape of a pan or pot opening upwardly, and has the first flange portion 5a that supports the edge portion 1a of the diaphragm 1, the second flange portion 5b that supports the outer peripheral edge of the damper 2, and a mounting portion 5c on which the magnetic circuit system 11 is placed.

The first flange portion 5a is formed in a position of the upper part of the resin frame 5, and the second flange portion 5b is formed in a position of the central part of the resin frame 5. The mounting portion 5c is formed in a position at the lower part side of the resin frame 5, namely, at the rear side thereof. A recess having a truncated cone shape is formed in the vicinity of the central axis of the mounting portion 5c from the lower surface side to the upper surface side thereof. The mounting portion 5c has an opening 5d on the central axis thereof, a step portion 5j and a hole portion 5k in the vicinity of the peripheral edge thereof, and a recess (concave) portion 5e and a slit 5m at the rear side thereof. The step portion 5j, the hole portion 5k, the recess portion 5e and the slit 5m serve to prevent production of air bubbles of an adhesive agent 60 due to volume change of space between the magnetic circuit system 11 and the resin frame 5 at the time of assembly of the speaker unit 50 for low-frequency band reproduction. A fastening member 41, which will be described later, penetrates the opening 5d, and a nameplate 42, which will be described later, is attached to the recess portion 5e. The name plate 42 is used for application of improvement of the appearance of the rear side of the speaker 100 or recognition of product information etc. for users.

Next, the respective constitutive elements of the magnetic circuit system 11 will be described.

The magnetic circuit system 11 is formed as an external magnet type magnetic circuit. This magnetic circuit has the pole piece 6, the annular magnet 7 and the annular plate 8.

The pole piece 6 has an inverted T section. The pole piece 6 is fixed onto the mounting portion 5c of the resin frame 5 via the adhesive agent 60. The pole piece 6 has a flange-like yoke 6a, a center pole 6b having a cylindrical shape, and openings 6c and 6d provided within the center pole 6b.

The yoke 6a is located on the mounting portion 5c of the resin frame 5. A recess having a truncated cone shape is formed in the vicinity of the central axis of the lower surface side of the center pole 6b. The openings 6c and 6d formed within the center pole 6b are respectively different in diameter, and the openings communicate with each other. The opening 6c has a diameter slightly larger than that of the opening 6d, and is formed from the vicinity of the central part of the center pole 6b to the upper part thereof. On the other hand, the opening 6d is formed at the lower end side of the opening 6c, namely, from the central part side of the center pole 6b to the lower part thereof. Further, a lower end portion 40bc of the supporting member 40, which will be described later, is inserted into the opening 6c and the supporting member 40 is fastened to the center pole 6b. Furthermore, the fastening member 41 penetrates the openings 6c and 6d. Note that the fastening member 41 penetrates the opening 6c via a thorough hole 40bb of the supporting member 40, which will be described later.

The annular magnet 7 is disposed so as to be overlapped with the upper surface of the yoke 6a, and the annular plate 8 is disposed so as to be overlapped with the upper surface of the annular magnet 7. The center pole 6b upwardly extends within the openings of the central parts of the annular magnet 7 and the annular plate 8. The outer peripheral edge of the plate 8 is fixed for reinforcement to the inner circumferential wall of the resin frame 5 via the adhesive agent 60.

In the magnetic circuit system 11, a magnetic circuit is formed by the magnet 7, the plate 8 and the pole piece 6, and the magnetic flux of the magnet 7 is concentrated in the magnetic gap 33 formed between the inner circumferential wall of the plate 8 and the outer circumferential wall of the pole piece 6.

The resin grille 21 is made of a resin material, for example, and has a function of protecting the speaker unit 50 for low-frequency band reproduction and the speaker unit 51 for high-frequency band reproduction, or the like. For this purpose, the resin grille 21 is mounted on the resin frame 5 so as to cover the speaker units. Further, striped spacings (not shown) are formed intermittently at the upper surface side of the resin grille 21 so that the speaker unit 50 for low-frequency band reproduction and the speaker unit 51 for high-frequency band reproduction can emit sound waves through the spacings to the sound output side.

Next, the speaker unit 51 for high-frequency band reproduction will be described. The speaker unit 51 for high-frequency band reproduction mainly includes a vibration system 30 having a diaphragm 61, a voice coil 14 and an upper frame 15, and a magnetic circuit system 31 having a pole piece 16, an annular magnet 17 and an annular plate 18, and a cover 23.

First, the respective constitutive elements of the vibration system 30 will be described.

The diaphragm 61 is a so-called domical diaphragm, and is formed integrally with an edge portion 61a. Various kinds of materials such as paper, polymer, or metal can be applied to the diaphragm 61 according to various kinds of application as well as the above diaphragm 1. The outer peripheral edge of the diaphragm 61, namely, the lower end part of outer peripheral edge of the edge portion 61a is fixed onto the upper surface of the resin frame 15.

The voice coil 14 has a substantially cylindrical shape. The outer circumferential wall of the voice coil 14 faces the inner circumferential wall of the annular plate 18 with a certain space therebetween. On the other hand, the inner circumferential wall of the voice coil 14 faces the outer circumferential wall of the upper end part of the pole piece 16 with a certain space therebetween. Thus, a gap (magnetic gap 34) is formed between the outer circumferential wall of the pole piece 16 and the inner circumferential wall of the plate 18.

Further, the voice coil 14 has positive/negative lead terminals (not shown). The positive side lead terminal is an input terminal of L (or R) channel signal, and the negative side lead terminal is an input terminal of ground (GND: earth) signal. The respective lead terminals are electrically connected to the ends of respective tinsel wires (not shown) and the other ends of the respective tinsel wires (not shown) are electrically connected to a connection terminal (not shown) To the voice coil 14, electric signals for one channel are input from an amplifier (not shown) side via the connection terminal and the tinsel wires.

The upper frame 15 is made of a resin material and has a substantially annular form. The upper frame 15 is disposed so as to be overlapped with the upper surface of the annular plate 18. The upper frame 15 supports the outer peripheral edge of the diaphragm 61, namely, the edge 61a.

Next, the respective constitutive elements of the magnetic circuit system 31 will be described.

The magnetic circuit system 31 is formed as an external magnet type magnetic circuit system. The magnetic circuit has the pole piece 16, the annular magnet 17 and the annular plate 18.

The pole piece 16 has an inverted T section. Flatness is ensured in the lower surface of the pole piece 16. The pole piece 16 is fixed onto an upper end surface 40ba of the supporting member 40 via the adhesive agent 60 (not shown). The pole piece 16 has a flange-like yoke 16a, a center pole 16b having a cylindrical shape, a fastening hole 16c provided within the center pole 16b, and a step portion 16d formed between the outer peripheral edge of the lower end part of the center pole 16b and the yoke 16a and having a step-like section.

The yoke 16a is located on the upper end surface 40ba of the supporting member 40. A recess having a truncated cone shape is formed in the vicinity of the central axis of the lower surface side of the center pole 16b. The fastening hole 16c has a female thread, for example, and the leading end (for example, male thread) of the fastening member 41 is inserted and screwed. The outer circumferential wall of the step portion 16d is in contact with the outer circumferential wall of the lower end part of the magnet 17.

The annular magnet 17 is disposed so as to be overlapped with the upper surface of the yoke 16a. The inner circumferential wall of the lower end part of the annular magnet 17 is disposed at the outer circumferential side of the step portion 16d of the pole piece 16 as described above, and the annular magnet 17 is precisely positioned in a predetermined position on the yoke 16a. The annular plate 18 is disposed so as to be overlapped with the upper surface of the annular magnet 17.

In the magnetic circuit system 31, a magnetic circuit is formed by the magnet 17, the plate 18 and the pole piece 16, and the magnetic flux of the magnet 17 is concentrated in the magnetic gap 34 formed between the inner circumferential wall of the plate 18 and the outer circumferential wall of the pole piece 16.

The cover 23 is made of a resin material, for example, and mounted on a frame portion 40a of the supporting member 40, which will be described later, for covering the sound output side of the speaker unit 51 for high-frequency band reproduction. The cover 23 has a function of protecting the speaker unit 51 for high-frequency band reproduction, or the like.

As other various members of the speaker device 100, the supporting member 40, the fastening member 41 and the nameplate 42 are included.

The supporting member 40 has the connecting portion 40b having a cylindrical shape and the frame portion 40a extending from the upper end surface 40ba of the connecting portion 40b upwardly so as to cover the periphery of the speaker unit 51 for high-frequency band reproduction. The cover 23 is mounted on the frame portion 40a and covers the speaker unit 51 for high-frequency band reproduction. The connecting portion 40b coaxially arranges the speaker unit 50 for low-frequency band reproduction and the speaker unit 51 for high-frequency band reproduction. The lower end part 40bc of the connecting portion 40b is inserted into the opening 6c of the pole piece 6 and fastened as described above. The speaker unit 51 for high-frequency band reproduction is fixed to the upper end surface 40ba having flatness via the adhesive agent 60 (not shown). The through hole 40bb is formed within the connecting portion 40b so that it penetrates on the central axis thereof in a vertical direction, and the fastening member 41 penetrates the through hole 40bb.

As the fastening member 41, for example, a member such as a male screw or bolt is appropriate. At the leading end of the fastening member 41, a male thread corresponding to the female thread of the fastening hole 16c is formed. The fastening member 41 is inserted into the fastening hole 16c from the rear side of the speaker device 100 through the openings 5d, 6d and 6c and the through hole 40bb. Thereby, the speaker unit 50 for low-frequency band reproduction and the speaker unit 51 for high-frequency band reproduction are coaxially fixed via the supporting member 40.

The nameplate 42 is made of a polymer material or metal material and has a disc shape. The nameplate 42 is attached to the recess portion 5e of the resin frame 5 with a sticking agent or adhesive agent as described above. The product information, company name, etc. are printed on the nameplate 42.

In the above described speaker device 100, when electric signals are input to the respective tinsel wires from the amplifier side, the electric signals are supplied to the voice coils 4 and 14 via the respective lead terminals of the voice coils 4 and 14. Thereby, driving forces are generated in the voice coils 4 and 14 within the magnetic gaps 33 and 34, respectively, and the diaphragms 1 and 61 are vibrated in the axis direction of the speaker device 100. Thus, the speaker device 100 emits sound waves to the sound output side.

### [Structure of Waterproof Damper]

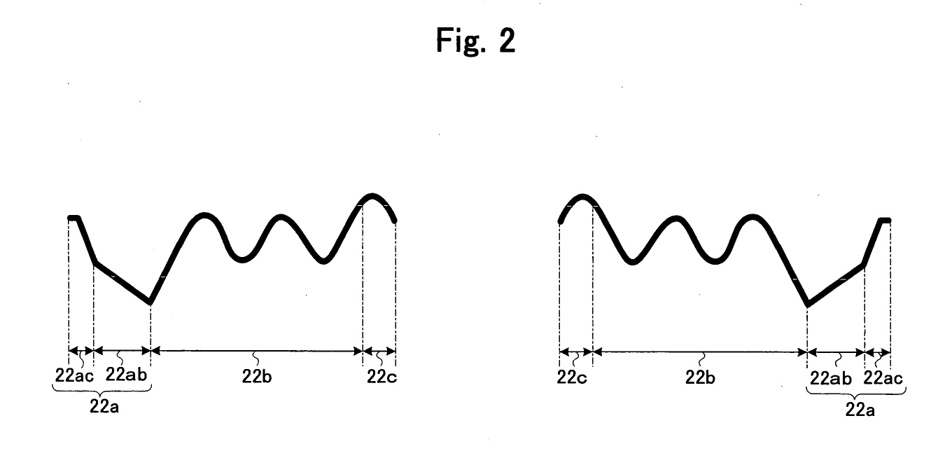

Next, the description will be given of a structure of the waterproof damper 22 which is a characteristic of the present invention, with reference to FIGS. 1A and 1B to FIG. 2. FIG. 2 shows an enlarged sectional view taken along a cutting surface through a diameter of the waterproof damper 22 having the disc shape.

As shown in FIG. 2, the waterproof damper 22 has an outer peripheral edge portion 22a, an elastic portion 22b and an inner peripheral edge portion 22c. Moreover, the outer peripheral edge portion 22a has a fixing portion 22ab and a bent portion 22ac.

The fixing portion 22ab is provided between the bent portion 22ac and the elastic portion 22b, and is fixed to the sound output side of the diaphragm 1 by the adhesive agent 60. The bent portion 22ac extends from one end of the fixing portion 22ab to the outer peripheral direction, and is bent upward. In a state that the waterproof damper 22 is fixed to the diaphragm 1, the bent portion 22ac is raised on the sound output side of the speaker device 100.

When cross-sectionally observed, the elastic portion 22b is formed into a wave shape, and expands and shrinks in the axial direction of the speaker device 100 with the diaphragm 1 at the time of reproducing the sound. The inner peripheral edge portion 22c extends from one end of the elastic portion 22b to the inner peripheral direction, and is fixed to the outer circumferential wall located at the upper portion of the connecting portion 40b of the supporting member 40 by the adhesive agent.

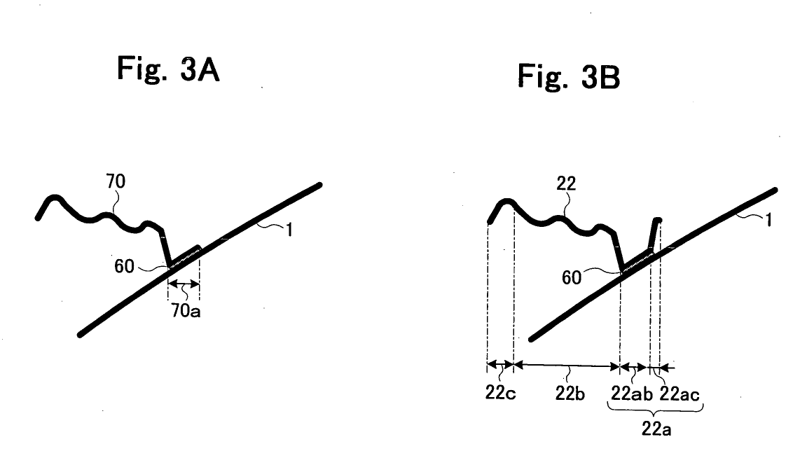

In the speaker device 100 including the waterproof damper 22 having such the structure, even if the waterdrop enters the diaphragm 1 through the gap of the resin grill 21, the waterdrop is cut off by the waterproof damper 22 and never enters the magnetic circuit system 11. Next, the description will be given of the operation and effect of the waterproof damper 22 which is the characteristic of the present invention, with reference to FIGS. 3A and 3B. For convenience of the explanation, an ordinary waterproof damper 70 having no bent portion at the outer peripheral edge portion and the waterproof damper 22 according to this embodiment are compared and explained below. FIG. 3B shows a sectional view in which an area E6 (an area surrounded by the broken line) in FIG. 1A is enlarged. Meanwhile, FIG. 3A shows a sectional view in which the area of the ordinary waterproof damper 70, corresponding to FIG. 3B, is enlarged. In addition, FIGS. 3A and 3B explain how the outer peripheral edge portion of the waterproof damper erodes/swells by a solvent.

First, before the operation and effect of the ordinary waterproof damper 70 and the waterproof damper 22 are explained, the structural difference of them will be described. As understood with reference to FIGS. 3A and 3B, unlike the waterproof damper 22 of this embodiment, the bent portion is not formed at the outer peripheral edge portion 70a of the ordinary waterproof damper 70. The outer peripheral edge portion 70a of the ordinary waterproof damper 70 is fixed to the sound output side of the diaphragm 1 via the adhesive agent 60. Meanwhile, as for the waterproof damper 22 of this embodiment, the fixing portion 22ab which is a component of the outer peripheral edge portion 22a is fixed to the sound output surface of the diaphragm 1 via the adhesive agent 60, and the bent portion 22ac is formed on the outer peripheral side of the fixing portion 22ab.

Each of the outer peripheral edge portion 70a of the waterproof damper 70 and the outer peripheral edge portion 22a of the waterproof damper 22 is fixed to the diaphragm 1 by the adhesive agent 60. The waterproof damper 70 is made of a member, such as an elastomer, deformed by a solvent component included in the adhesive agent 60, for example. Therefore, at the time of attaching the outer peripheral edge portion 70a, the ordinary waterproof damper 70 shown in FIG. 3A is deformed by the solvent component of the adhesive agent, and is not properly attached.

On the contrary, as shown in FIG. 3B, in the embodiment of the present invention, since the bent portion 22ac is formed on the outer side of the adhesion surface (fixing portion) 22ab, the deformation of the adhesion surface 22ab can be suppressed or prevented.

Since the bent portion 22ac is formed as one portion of the waterproof damper 22, cost of manufacturing the waterproof damper 22 is never increased by forming the bent portion 22ac.

### MODIFICATION

In the above embodiment, the waterproof damper 22 of the present invention is applied to the coaxial speaker device 100, but the application of the present invention is not limited to this. Namely, the waterproof damper 22 according to the present invention can be applied to various kinds of speaker devices. Moreover, the present invention can be applied to a speaker device for a vehicle.

What is claimed is:

1. A speaker device comprising:
a supporting member which is disposed on a central axis of the speaker device;
a diaphragm which is provided at an outer circumference of the supporting member; and
a damper which has an inner peripheral edge portion fixed to the supporting member on a sound output side with respect to the diaphragm and an outer peripheral edge portion fixed to the diaphragm,
wherein the damper has a bent portion, which is raised on a side of the sound output, at an outer peripheral side with respect to a fixing position to the diaphragm.

2. The speaker device according to claim 1, wherein the damper is attached to the diaphragm at a fixing position on an inner peripheral side with respect to the bent portion.

3. The speaker device according to claim 1, wherein the damper has a waterproof property.

4. The speaker device according to claim 1, further comprising:
a frame which holds the supporting member; and
another damper which has an inner peripheral edge portion fixed to a member of a vibration system and an outer peripheral edge portion fixed to the frame.
